(19) United States
(12) Patent Application Publication
(10) Pub. No.: US 2026/0170712 A1
(43) Pub. Date: Jun. 18, 2026

(54) VIDEO DATA PROCESSING METHOD, ELECTRONIC DEVICE AND NON-TRANSITORY STORAGE MEDIUM

(71) Applicant: Beijing Zitiao Network Technology Co., Ltd., Beijing (CN)

(72) Inventor: Jie WU, Beijing (CN)

(21) Appl. No.: 19/422,258

(22) Filed: Dec. 16, 2025

(30) Foreign Application Priority Data
Dec. 17, 2024 (CN) 202411865064.8

(51) Int. Cl. G06T 11/00; G06N 20/00

(52) U.S. Cl. CPC G06T 11/00; G06N 20/00

(57) ABSTRACT

The present disclosure provides a video data processing method, an electronic device, and a non-transitory storage medium. The method includes: in response to a video generation request, obtaining first text prompt information corresponding to the video generation request; and inputting the first text prompt information into a first video generation model to obtain first video data corresponding to the video generation request. The first video generation model is obtained by training a diffusion model via second video data, the second video data is generated by a second video generation model, and model parameters of the second video generation model are associated with model parameters of the diffusion model during model training.

### CROSS-REFERENCE TO RELATED APPLICATION

This application claims the priority to and benefits of the Chinese Patent Application No. 202411865064.8, which was filed on Dec. 17, 2024. The aforementioned patent application is hereby incorporated by reference in its entirety.

### TECHNICAL FIELD

Embodiments of the present disclosure relate to the technical field of computer processing, and more particularly, to a video data processing method, an electronic device and a non-transitory storage medium.

### BACKGROUND

In the related art, video data is often generated using image data. However, this video data generation method usually requires collecting a large amount of image data, resulting in high data acquisition costs. Due to the difference of image data, the quality of the generated videos is often unstable, with problems such as picture jitter and color distortion. In addition, the input of a large amount of image data and complex model calculations easily lead to low video generation efficiency, making it impossible to respond to video generation needs relatively quickly.

### SUMMARY

The present disclosure provides a video data processing method, an electronic device and a non-transitory storage medium to achieve the technical effect of improving the quality and efficiency of video generation.

An embodiment of the present disclosure provides a video data processing method including:
in response to a video generation request, obtaining first text prompt information corresponding to the video generation request; and
inputting the first text prompt information into a first video generation model to obtain first video data corresponding to the video generation request; where the first video generation model is obtained by training a diffusion model via second video data; the second video data is generated by a second video generation model; and model parameters of the second video generation model are associated with model parameters of the diffusion model during model training.

The embodiment of the present disclosure also provides a video data processing apparatus including:
a video generation request module configured to, in response to a video generation request, obtain first text prompt information corresponding to the video generation request; and
a video data generation module configured to input the first text prompt information into a first video generation model to obtain first video data corresponding to the video generation request; where the first video generation model is obtained by training a diffusion model via second video data; the second video data is generated by a second video generation model; and model parameters of the second video generation model are associated with model parameters of the diffusion model during model training.

Embodiments of the present disclosure also provide an electronic device including:
one or more processors; and
a storage for storing one or more programs,
where when the one or more programs are executed by the one or more processors, the one or more processors are caused to implement the video data processing method according to any one of the embodiments of the present application.

Embodiments of the present disclosure also provide a storage medium containing computer-executable instructions, where when executed by a computer processor, the computer-executable instructions are used for executing the video data processing method according to any one of the embodiments of the present application.

Embodiments of the present disclosure also provide a computer program product including a computer program, where when executed by a processor, the computer program implements the video data processing method according to any one of the embodiments of the present application.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flowchart of a video data processing method according to an embodiment of the present disclosure;

FIG. 2 is a schematic flowchart of another video data processing method according to an embodiment of the present disclosure;

FIG. 3 is a schematic flowchart of an alternative example of a video data processing method according to an embodiment of the present disclosure;

FIG. 4 is a schematic structural diagram of a video data processing apparatus according to an embodiment of the present disclosure; and

FIG. 5 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It may also be understood that the data (including but not limited to the data itself, data acquisition, or use) involved in the technical solutions of the present disclosure shall comply with the requirements of the corresponding laws, regulations, and related provisions.

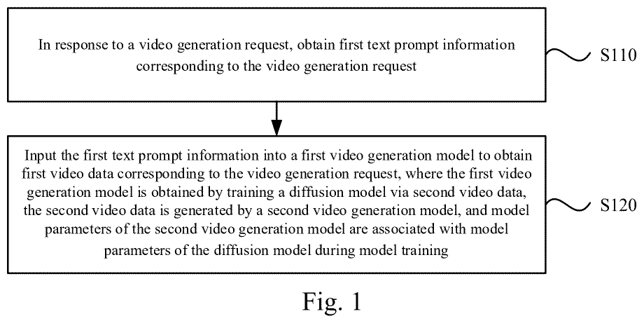

FIG. 1 is a schematic flowchart of a video data processing method according to an embodiment of the present disclosure. The embodiment of the present disclosure is applicable to scenarios of generating video data based on text information. The method may be executed by a video data processing apparatus, which may be implemented in software and/or hardware. Alternatively, the apparatus may be implemented through an electronic device, which may be a mobile terminal, PC, server, etc.

As shown in FIG. 1, the method of the present embodiment may specifically include steps S110 and S120.

At step S110, in response to a video generation request, acquire first text prompt information corresponding to the video generation request.

The video generation request may be understood as a request for generating video data. In the embodiment of the present disclosure, the video generation request is obtained by in response to a video generation trigger operation, generating the video generation request based on the video generation trigger operation. In the embodiment of the present disclosure, the video generation request may include text content for generating the video and may also include audio content for generating the video. In the embodiment of the present disclosure, the video generation request includes content for audio generation, and text content for video generation corresponding to the content for audio generation can be generated based on the content for audio generation. The first text prompt information may be understood to include at least descriptive information about the video descriptive content that is expected to be obtained. Alternatively, the first text prompt information may include at least one of a video theme, a video element, a video background, and a video duration. Alternatively, presentation form of the first text prompt information may include at least one of a sentence, a paragraph, or a keyword.

In the embodiment of the present disclosure, there are a plurality of methods for obtaining the first text prompt information corresponding to the video generation request. For example, the video generation request may be parsed to obtain the first text prompt information in the video generation request. Or, first text prompt information corresponding to the video generation request uploaded by a client which initiates the video generation request is received. Or, a plurality of candidate text prompt information may be displayed. In response to a selection operation for the candidate text prompt information, the selected text prompt information may be taken as the first text prompt information. Or, the text data is generated by a text generation control. Or, text data is input via a preset text input control, or text data is received via a preset data receiving interface, or text data obtained after processing are obtained via a target operation, etc.

At step S120, input the first text prompt information into a first video generation model to obtain first video data corresponding to the video generation request, where the first video generation model is obtained by training a diffusion model via second video data; the second video data is generated by a second video generation model; and model parameters of the second video generation model are associated with model parameters of the diffusion model during model training.

The first video data may be understood to be video data generated from the first text prompt information using the first video generation model. The first video generation model may be understood as a video generation model for obtaining first video data corresponding to a video generation request. In the embodiment of the present disclosure, compared with the cumbersome process of obtaining image data, which requires relevant personnel to produce image data using professional equipment, obtaining the text prompt information does not require professional technology for specific image production, saving time and effort, and being more convenient. In the embodiment of the present disclosure, the first video generation model may be obtained by training a pre-constructed diffusion model based on the second video data. The second video data may include a plurality of video data generated using the second video generation model. Specifically, sample data for generating a video may be obtained, where the sample data may include second text prompt information for generating the video. Further, the second text prompt information may be input to the second video generation model. Thus, a plurality of video data corresponding to the second text prompt information may be obtained, i.e., a plurality of second video data is obtained. In the embodiment of the present disclosure, the second video generation model may be a video generation model capable of generating video data that has been previously trained. In the embodiment of the present disclosure, the model parameters of the second video generation model are associated with the model parameters of the diffusion model during the model training. That is, the model parameters of the second video generation model may be determined based on the model parameters of the diffusion model during model training.

Exemplarily, during the model training of the diffusion model, model parameter adjustments may be made to the diffusion model based on model inputs and model outputs of the diffusion model. On this basis, the model parameters of the second video generation model may also be determined according to the model parameters of the diffusion model. On this basis, model parameters (e.g., loss functions, model structures, and/or parameter weights, etc.) may also be adjusted for the second video generation model based on the model inputs and model outputs of the second video generation model.

As an alternative implementation of an embodiment of the present disclosure, the model structure of the second video generation model is the same as the model structure of the diffusion model. The following may be specifically included: the hierarchy structure in the second video generation model is the same as the hierarchy structure in the diffusion model, the connection manner between the hierarchies in the second video generation model is the same as the connection manner between the hierarchies in the diffusion model, and the number and type of parameters in the second video generation model are the same as the number and type of parameters in the diffusion model. In the embodiment of the present disclosure, the model structure of the second video generation model is the same as the model structure of the diffusion model, which has the advantage of enabling the video data generated by the second video generation model to better reflect the performance of the diffusion model, thereby improving the generation quality of the first video generation model. Alternatively, the second video generation model may be obtained through training on the basis of the diffusion model.

On the basis of the embodiments described above, the model parameters of the second video generation model may be updated to the model parameters of the diffusion model in response to a first trigger event during the training of the diffusion model. In the embodiment of the present disclosure, during the training of the diffusion model, the model parameters of the second video generation model are updated to the model parameters of the diffusion model, which not only enables the second video generation model to generate video data that better conform to expectations based on text prompt information, but also allows the diffusion model, during its training process, to generate continuously changing video content through the second video generation model (which undergoes parameter changes), thereby obtaining video data that is more compatible with the diffusion model in training, so as to enhance the training effectiveness of the diffusion model. Specifically, during the training of the diffusion model, in response to the first trigger event, the model parameters of the second video generation model may be replaced with the model parameters of the diffusion model such that the model parameters of the second video generation model are the same as the model parameters of the diffusion model. In the embodiment of the present disclosure, the first trigger event may include at least one of the model parameters of the diffusion model being updated, a preset first update time condition being satisfied, and a number of updates of the diffusion model reaching a first number threshold, etc. Specifically, the model parameters of the diffusion model are updated and the model parameters of the second video generation model are followed by the update. The first update time condition may be that the first model update time is reached, or may be that the first interval duration from the last model update time is reached. The first number threshold may be set according to actual requirements, which is not specifically limited herein. Illustratively, the first number threshold may be one, i.e., every time the diffusion model is updated, the second video generation model needs to be updated once. The first number threshold may be 3, i.e., for every three updates of the diffusion model, the second video generation model is updated once.

In the embodiment of the present disclosure, the model parameters of the first video generation model may be adjusted during training based on the video generation loss. The video generation loss may be determined based on the third video generation model. In the embodiment of the present disclosure, the video generation loss may be determined by using a direct preference optimization (DPO) algorithm. The third video generation model may serve as a reference model involved in the direct preference optimization algorithm. The model structure and parameters of the third video generation model may be fixed, or updated according to the model parameters of the diffusion model during the model training process. In an embodiment, the video generation loss may be determined based on a third video generation model or may be determined according to the third video generation model and the diffusion model. In the embodiment of the present disclosure, the model parameters of the third video generation model are associated with the model parameters of the diffusion model during the model training. That is, the model parameters of the third video generation model may be derived based on the model parameters of the diffusion model during model training.

Illustratively, during the model training of the diffusion model, model parameter adjustments may be made to the diffusion model based on model inputs and model outputs of the diffusion model. On this basis, the model parameters of the second video generation model may also be determined according to the model parameters of the diffusion model. On this basis, it is also possible to adjust model parameters (e.g., at least one of a loss function, a model structure, a parameter weight, etc.) of the third video generation model according to the model input and the model output of the third video generation model.

As an alternative to the embodiment of the present disclosure, the model structure of the third video generation model is the same as that of the diffusion model. Specifically, a hierarchical structure in the second video generation model is the same as that in the diffusion model, the connection between the hierarchical layers in the third video generation model is the same as that in the diffusion model, and the number and type of parameters in the third video generation model are the same as those in the diffusion model. In the embodiment of the present disclosure, the third video generation model may serve as a reference model and may be used to generate video data that has some association or contrast with the diffusion model.

On the basis of the embodiments described above, the model parameters of the third video generation model may be updated to the model parameters of the diffusion model in response to a second trigger event during the training of the diffusion model. The update frequency of the model parameters of the third video generation model is lower than that of the diffusion model, which may not only reduce training fluctuations caused by frequent parameters to a certain extent, help the diffusion model maintain a more stable performance during the training process, but also may reduce the consumption of computing resources. Specifically, during the training of the diffusion model, in response to a second trigger event, the model parameters of the third video generation model may be replaced with the model parameters of the diffusion model such that the model parameters of the third video generation model are the same as those of the diffusion model. In the embodiment of the present disclosure, the second trigger event may include meeting a preset second update time condition and/or the number of updates of the model parameters of the diffusion model reaching a second number threshold. The second update time condition may be that the second model update time is reached; or may be that the second interval duration from the last model update time is reached. It should be understood that the second interval duration is longer than the first interval duration. In the embodiment of the present disclosure, the second number threshold is greater than the first number threshold. The second number threshold may be set according to actual requirements, which is not specifically limited herein. Illustratively, the first number threshold may be 1 and the second number threshold may be 2. That is, after the diffusion model is updated for the first time, the second video generation model is also updated once, and the third video generation model is not updated; after the second update of the diffusion model, the second video generation model is updated again, and the third video generation model is updated once based on the second update of the diffusion model.

According to a technical solution of an embodiment of the present disclosure, first text prompt information corresponding to the video generation request is obtained in response to a video generation request. Compared with the cumbersome process of obtaining image data, which requires relevant personnel to produce image data using professional equipment, obtaining the text prompt information does not require professional technology for specific image production, saving time and effort, and being more convenient. Massive image data input and complex models tend to result in low video generation efficiency, but according to the technical solution, by inputting the first text prompt information into a first video generation model to obtain first video data corresponding to the video generation request, the technical problem in the related art is solved where video generation suffers from low efficiency due to generating video data from image data, and faster video generation is achieved using text prompt information, thus improving the efficiency of video generation. In the embodiment of the present disclosure, the first video generation model is obtained by training a diffusion model via second video data; the second video data is generated by a second video generation model; and model parameters of the second video generation model are associated with model parameters of the diffusion model during model training, so that the second video data generated by the second video generation model may be better matched with the diffusion model, and the video quality of the video generated by using the video generation model can be effectively improved.

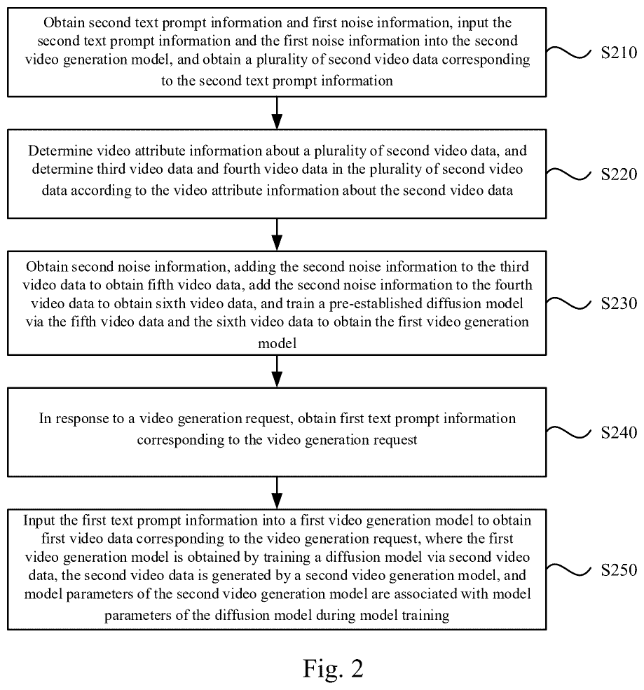

FIG. 2 is a schematic flowchart of another video data processing method according to an embodiment of the present disclosure. In the technical solution of the present embodiment, on the basis of the above-mentioned embodiment, the manner of training the diffusion model to obtain the first video generation model is further refined. Alternatively, the first video generation model is obtained through training by obtaining second text prompt information and first noise information, inputting the second text prompt information and the first noise information into a second video generation model, and obtaining a plurality of second video data corresponding to the second text prompt information; determining video attribute information about a plurality of second video data, and determining third video data and fourth video data in the plurality of second video data according to the video attribute information about the second video data, where the video attribute information is used for representing difference information about the second video data on interaction effect data; and obtaining second noise information, adding the second noise information to the third video data to obtain fifth video data, adding the second noise information to the fourth video data to obtain sixth video data, and training a pre-established diffusion model via the fifth video data and the sixth video data to obtain the first video generation model. Specific implementation methods may refer to the descriptions of the present embodiment. The same or similar technical features as those of the previous embodiments will not be described in detail. As shown in FIG. 2, the method of the present embodiment may specifically include steps S210 to S250.

At step S210, obtain second text prompt information and first noise information, input the second text prompt information and the first noise information into a second video generation model, and obtain a plurality of second video data corresponding to the second text prompt information.

In the embodiment of the present disclosure, the second text prompt information may be used to describe video content intended to be generated to generate a plurality of second video data. Alternatively, the presentation form of the second text prompt information may include at least one of a sentence, a paragraph, or a keyword. Alternatively, the second text prompt information may include at least one of a video theme, a video element, a video background, a video duration, etc. In the embodiment of the present disclosure, the manner in which the second text prompt information is obtained may be varied. For example, the second text prompt information may be derived based on a text prompt information input operation in response to the text prompt information input operation. Or, the second text prompt information may be derived based on a data set that includes text prompt information for generating the video. Or, the video subtitle data may be obtained such that the second text prompt information may be derived based on video subtitle data. In the embodiment of the present disclosure, the first noise information may be random noise information, or may be sample noise information.

In the embodiment of the present disclosure, in generating the plurality of second video data, the introduction of the first noise information may cause the generated plurality of second video data to differ in detail, but should conform to the description of the second text prompt information as a whole. In the embodiment of the present disclosure, the inputting the second text prompt information and the first noise information into a second video generation model may include obtaining model input data based on the second text prompt information and the first noise information and inputting the model input data into the second video generation model. Alternatively, the first noise information may be added to the second text prompt information to obtain noisy text information. Thereby, noisy text information may be input into the second video generation model.

In the embodiment of the present disclosure, generating a plurality of second video data using the second text prompt information may ensure that the data distribution of the training model is aligned. This alignment ensures that the model can learn stable and consistent video data representations during the training process, thereby helping to improve the model's performance and generalization ability.

At step S220, determine video attribute information about a plurality of second video data, and determine third video data and fourth video data in the plurality of second video data according to the video attribute information about the second video data.

The video attribute information may be used for representing difference information about the second video data on interaction effect data. In the embodiment of the present disclosure, by selecting video data with different interaction effects for training, specifically, video data with significant differences in interaction effects may be filtered, this enables the diffusion model to learn how to generate high-quality videos more quickly, thereby improving training efficiency. In the embodiment of the present disclosure, the determining video attribute information about a plurality of second video data may include inputting the plurality of second video data into a video detection model respectively to obtain video attribute information about each of the second video data. The video detection model may be used for obtaining video attribute information about the second video data. Specifically, for each second video data, the second video data may be input into a video detection model, so that video attribute information corresponding to the second video data may be obtained. In the embodiment of the present disclosure, the video detection model may be obtained by training on a machine learning model based on the seventh video data and a video attribute tag corresponding to the seventh video data. Specifically, the seventh video data may be input into the machine learning model to obtain the actual video attribute information output by the machine learning model. Further, based on the actual video attribute information and the video attribute tag corresponding to the seventh video data, the model parameters of the machine learning model may be adjusted to obtain a video detection model.

The seventh video data may be understood to be video data for training a machine learning model. In the embodiment of the present disclosure, there are various ways of obtaining the seventh video data. For example, the video data may be generated using the video generation model as the seventh video data. Or, a video shooting apparatus (e.g., a camera) may be used for video shooting to obtain the seventh video data. In the embodiment of the present disclosure, the video attribute tag may be understood to be an expected result of the video attribute information about the seventh video data. In the embodiment of the present disclosure, the machine learning model may be set according to actual needs, which is not specifically limited herein. There is a difference between the video attribute information about the third video data and the video attribute information about the fourth video data.

In the embodiment of the present disclosure, the determining third video data and fourth video data in the plurality of second video data according to the video attribute information about the second video data may include: selecting two pieces of second video data with different video attribute information selected according to the video attribute information about the second video data. Further, the selected two pieces of second video data may be taken to as the third video data and the fourth video data, respectively. Alternatively, the selecting two pieces of second video data with different video attribute information selected according to the video attribute information about the second video data may include randomly selecting two pieces of second video data having a difference in video attribute information according to the video attribute information about the second video data; or, determining two pieces of second video data having the largest difference in video attribute information according to the video attribute information about the second video data. Illustratively, the third video data may be the second video data whose video attribute information meets expectations, and the fourth video data may be the second video data whose video attribute information does not meet expectations.

At step S230, obtain second noise information, add the second noise information to the third video data to obtain fifth video data, add the second noise information to the fourth video data to obtain sixth video data, and train a pre-established diffusion model via the fifth video data and the sixth video data to obtain the first video generation model.

The second noise information may be random noise information, or may be sample noise information. The fifth video data may be video data obtained by adding the second noise information to the third video data. The sixth video data may be video data obtained by adding the second noise information to the third video data. In the embodiment of the present disclosure, the fifth video data and the sixth video data are obtained by adding the same noise corresponding to the same time step to the third video data and the fourth video data, respectively. In the embodiment of the present disclosure, the addition of the second noise information to the video data may make the generated video richer in content, natural, and more conform to a user's expectation. In the embodiment of the present disclosure, by adding noise to and training video data with different interaction effects, namely, adding second noise information to and training third video data and fourth video data, respectively, so that a model may generate video data with different effects, the differentiation requirements of the video data can be met. In the embodiment of the present disclosure, training the pre-established diffusion model with the fifth video data and the sixth video data enables the diffusion model to learn how to generate video data corresponding to the input text prompt data from noise and to generate a video having a desired interaction effect, thereby enabling the first video generation model to generate high-quality, diverse video data closely related to the input text prompt.

In the embodiment of the present disclosure, the training a pre-established diffusion model via the fifth video data and the sixth video data to obtain the first video generation model may include: inputting the second text prompt information, the fifth video data and the sixth video data into a pre-established diffusion model, and obtaining third noise information corresponding to the fifth video data and fourth noise information corresponding to the sixth video data, respectively; and inputting the second text prompt information, the fifth video data and the sixth video data into the third video generation model, and obtaining fifth noise information corresponding to the fifth video data and sixth noise information corresponding to the sixth video data, respectively; and determining the video generation loss according to the third noise information, the fourth noise information, the fifth noise information and the sixth noise information, adjusting the model parameters of the diffusion model according to the video generation loss, and determining the trained diffusion model as the first video generation model in response to a third trigger event.

The third noise information may be noise information in the fifth video data obtained after inputting the second text prompt information, the fifth video data and the sixth video data into a pre-established diffusion model. The fourth noise information may be noise information in the sixth video data obtained by inputting the second text prompt information, the fifth video data and the sixth video data into a pre-established diffusion model. The fifth noise information may be noise information in the fifth video data obtained by inputting the second text prompt information, the fifth video data and the sixth video data into a third video generation model. The sixth noise information may be noise information in the sixth video data obtained after inputting the second text prompt information, the fifth video data and the sixth video data into a third video generation model.

In the embodiment of the present disclosure, the determining video generation loss according to the third noise information, the fourth noise information, the fifth noise information and the sixth noise information may specifically include, determining the video generation loss based on the third noise information, the fourth noise information, the fifth noise information and the sixth noise information using a direct preference optimization algorithm.

In the embodiment of the present disclosure, the third trigger event may include the video attribute information about the second video data satisfying a preset change condition. The preset change condition may be set according to actual requirements, which is not specifically defined herein. For example, the video attribute information about each second video data reaches the expected video attribute information; or video attribute information about a preset amount of second video data may reach expected video attribute information; or the video attribute information of each second video data falls within the range of preset video attribute information; or there is video attribute information about the second video data of a preset proportion reaching the expected video attribute information. The third trigger event may also include: the video generation loss function reaches a preset convergence condition; or the video data of the trained diffusion model reaches a preset error condition; or, the number of adjustments of the model parameters reaches a preset number of adjustments. It should be noted that the preset convergence condition, the preset error condition and the preset number of adjustments may be set according to actual requirements, which is not specifically limited herein.

At step S240, in response to a video generation request, obtain first text prompt information corresponding to the video generation request.

At step S250, input the first text prompt information into a first video generation model to obtain first video data corresponding to the video generation request, where the first video generation model is obtained by training a diffusion model via second video data; the second video data is generated by a second video generation model; and model parameters of the second video generation model are associated with model parameters of the diffusion model during model training.

According to a technical solution of an embodiment of the present disclosure, by obtaining second text prompt information and first noise information, inputting the second text prompt information and the first noise information into a second video generation model, and obtaining a plurality of second video data corresponding to the second text prompt information, the distribution of training data is aligned, so that the model may learn a stable and consistent presentation form of the video data during the training process, thereby helping to improve the performance and generalization of the model. Video attribute information about a plurality of second video data is determined, and third video data and fourth video data in the plurality of second video data are determined according to the video attribute information about the second video data; where the video attribute information is used for representing difference information about the second video data on interaction effect data. In the technical solution, training is performed by selecting video data having different interaction effects, so that a diffusion model may learn how to generate a high-quality video more quickly, thereby improving training efficiency. Second noise information is obtained, the second noise information is added to the third video data to obtain fifth video data, and the second noise information is added to the fourth video data to obtain sixth video data. A pre-established diffusion model is trained via the fifth video data and the sixth video data to obtain the first video generation model. In the embodiment of the present disclosure, by adding noise to and training video data with different interaction effects, namely, adding second noise information to and training third video data and fourth video data, respectively, so that a model can generate video data with different styles and special effects to satisfy video diversification requirements.

As an alternative example of an embodiment of the present disclosure, an embodiment of the present disclosure provides a schematic architecture diagram showing model training for a video data processing method. In the embodiment of the present disclosure, the first video generation model may be obtained by training based on a preconstructed diffusion model. The second video generation model may be a diffusion model configured to generate video data according to the second text prompt information and the first noise information; where the model structure of the second video generation model is the same as the model structure of the preconstructed diffusion model. The third video generation model may be a diffusion model having the same model structure as the model structure of the pre-constructed diffusion model. The video detection model may be understood as a model for obtaining video attribute information about video data. The video detection model may be derived by training a machine learning model with video data and video attribute tags corresponding to the video data.

In the embodiment of the present disclosure, a first number threshold for updating the model parameters of the second video generation model and a second number threshold for updating the model parameters of the third video generation model are preset respectively according to the number of updates of the model parameters of the diffusion model, where the first number threshold is smaller than the second number threshold. The advantage of this arrangement is that it may not only ensure the stability of the diffusion model in the training process, but also enable the diffusion model to learn new video data online to enable the first video generation model to generate from text prompt information the video data that better conforms to expectations to meet the diversified requirements of video generation.

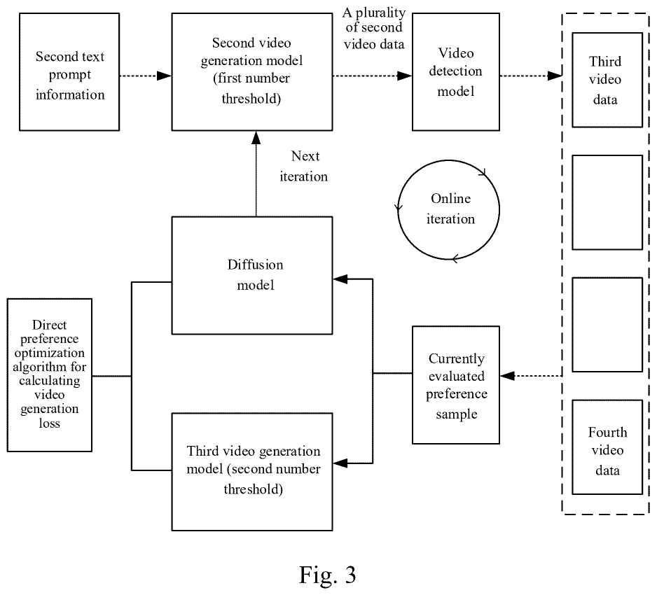

As shown in FIG. 3, the second text prompt information and the first noise information may be obtained. Thus, the second text prompt information and the first noise information may be input into the second video generation model. Further, a plurality of second video data corresponding to the second text prompt information may be obtained. After obtaining the plurality of second video data, the plurality of second video data may be input to a video detection model to obtain video attribute information about each of the second video data. Further, according to the video attribute information about the second video data, two video data, i.e., third video data and fourth video data, of the difference information about the interaction effect data in the plurality of second video data may be selected.

In the embodiment of the present disclosure, the currently evaluated preference sample may be derived based on the third video data and the fourth video data. Specifically, second noise information is added to the third video data to obtain fifth video data, and the second noise information is added to the fourth video data to obtain sixth video data. That is, the currently evaluated preference sample may include five video data and sixth video data.

On this basis, the second text prompt information, the fifth video data and the sixth video data may be input into a pre-established diffusion model, and third noise information corresponding to the fifth video data and fourth noise information corresponding to the sixth video data are respectively obtained; and the second text prompt information, the fifth video data and the sixth video data are input into the third video generation model, and fifth noise information corresponding to the fifth video data and sixth noise information corresponding to the sixth video data are respectively obtained. Further, the third noise information, the fourth noise information, the fifth noise information, and the sixth noise information may be used to calculate a video generation loss using a DPO algorithm. Thus, the model parameters of the diffusion model may be adjusted according to the video generation loss. In response to the video attribute information about the second video data reaching preset expected video attribute information, the training of the diffusion model is discontinued, and the trained diffusion model is determined as a first video generation model.

During the training of the diffusion model, the model parameters of the second video generation model may be updated to the model parameters of the diffusion model in response to the number of updates of the model parameters of the diffusion model reaching a first number threshold. The model parameters of the third video generation model may be updated to the model parameters of the diffusion model in response to the number of updates of the model parameters of the diffusion model reaching a second number threshold.

On the basis of the above-mentioned embodiment, during model training, in response to a video generation request, first text prompt information corresponding to the video generation request may be obtained. Further, the first text prompt information may be input to the first video generation model, so that video data output by the first video data generation model, i.e., the first video data, may be obtained.

The technical solution of the embodiments of the present disclosure addresses the technical problems in video generation in the related art where video generation efficiency is relatively low and quality is poor. It achieves not only intelligent generation of video data that better conforms to expectations based on text prompt information, but also enables online learning of new video data during the training of the diffusion model to adapt to constantly changing video content requirements, thereby improving both the quality and efficiency of video generation.

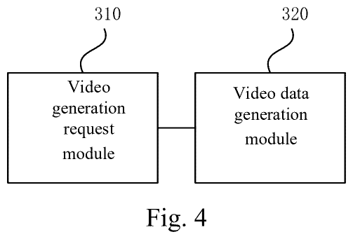

FIG. 4 is a schematic structural diagram of a video data processing apparatus according to an embodiment of the present disclosure. As shown in FIG. 4, the apparatus includes: a video generation request module 310 and a video data generation module 320. The video generation request model 310 is configured to, in response to a video generation request, obtain first text prompt information corresponding to the video generation request; and the video data generation module 320 is configured to input the first text prompt information into a first video generation model to obtain first video data corresponding to the video generation request; where the first video generation model is obtained by training a diffusion model via second video data; the second video data is generated by a second video generation model; and model parameters of the second video generation model are associated with model parameters of the diffusion model during model training.

According to a technical solution of an embodiment of the present disclosure, first text prompt information corresponding to the video generation request is obtained by the video generation request model in response to a video generation request. The technical solution of the present disclosure overcomes the cumbersome process in the related art where obtaining image data requires specialized personnel to produce image data using professional equipment, whereas obtaining text prompt information does not need specialized image production techniques, saving time and effort, and providing greater convenience. Massive image data input and complex models tend to result in low video generation efficiency. But according to the technical solution, by inputting the first text prompt information into a first video generation model via a video data generation module to obtain first video data corresponding to the video generation request, the technical problem in the related art is solved where video generation suffers from low efficiency due to generating video data from image data, and faster video generation is achieved using text prompt information, thus improving the efficiency of video generation. In the embodiment of the present disclosure, the first video generation model is obtained by training a diffusion model via second video data; the second video data is generated by a second video generation model; and model parameters of the second video generation model are associated with model parameters of the diffusion model during model training, so that the second video data generated by the second video generation model may be better matched with the diffusion model, and the video quality of the video generated by using the video generation model may be effectively improved.

On the basis of any alternative technical solution in the embodiment of the present disclosure, alternatively, the model structure of the second video generation model is the same as the model structure of the diffusion model; during training of the diffusion model, in response to a first trigger event, the model parameters of the second video generation model are updated to the model parameters of the diffusion model.

On the basis of any alternative technical solution in the embodiment of the present disclosure, alternatively, the first trigger event includes at least one of the model parameters of the diffusion model being updated, a preset first update time condition being satisfied, and a number of updates of the diffusion model reaching a first number threshold.

On the basis of any alternative technical solution in the embodiment of the present disclosure, alternatively, during training, the model parameters of the first video generation model are adjusted according to a video generation loss; the video generation loss is determined according to the third video generation model; the model parameters of the third video generation model are associated with the model parameters of the diffusion model during the model training.

On the basis of any alternative technical solution in the embodiment of the present disclosure, alternatively, a model structure of the third video generation model is the same as a model structure of the diffusion model; during the training of the diffusion model, in response to a second trigger event, the model parameters of the third video generation model are updated to the model parameters of the diffusion model; an update frequency of the model parameters of the third video generation model is lower than an update frequency of the model parameters of the diffusion model.

On the basis of any alternative technical solution in the embodiment of the present disclosure, alternatively, the second trigger event includes at least one selected from a group consisting of meeting a preset second update time condition and a number of updates of the model parameters of the diffusion model reaching a second number threshold.

On the basis of any alternative technical solution in the embodiment of the present disclosure, alternatively, the video data processing apparatus further includes a model training module. The model training module includes a second video data obtaining unit, a second video data analysis and determination unit and a first video generation model obtaining unit. The second video data obtaining unit is configured for obtaining second text prompt information and first noise information, inputting the second text prompt information and the first noise information into the second video generation model, and obtaining a plurality of second video data corresponding to the second text prompt information. The second video data analysis and determination unit is configured for determining video attribute information about a plurality of second video data, and determining third video data and fourth video data in the plurality of second video data according to the video attribute information about the second video data, where the video attribute information is used for representing difference information about the second video data on interaction effect data. The first video generation model obtaining unit is configured for obtaining second noise information, adding the second noise information to the third video data to obtain fifth video data, adding the second noise information to the fourth video data to obtain sixth video data, and training a pre-established diffusion model via the fifth video data and the sixth video data to obtain the first video generation model.

On the basis of any alternative technical solution in the embodiment of the present disclosure, alternatively, the second video data analysis and determination unit is configured for inputting the plurality of second video data into a video detection model respectively to obtain video attribute information about each of the second video data, where the video detection model is obtained by training a machine learning model based on the seventh video data and a video attribute tag corresponding to the seventh video data.

On the basis of any alternative technical solution in the embodiment of the present disclosure, alternatively, the first video generation model obtaining unit is configured for: inputting the second text prompt information, the fifth video data and the sixth video data into a pre-established diffusion model, and respectively obtaining third noise information corresponding to the fifth video data and fourth noise information corresponding to the sixth video data; inputting the second text prompt information, the fifth video data and the sixth video data into the third video generation model, and respectively obtaining fifth noise information corresponding to the fifth video data and sixth noise information corresponding to the sixth video data; and determining a video generation loss according to the third noise information, the fourth noise information, the fifth noise information and the sixth noise information, adjusting the model parameters of the diffusion model according to the video generation loss, and determining the diffusion model, which is trained, as the first video generation model in response to a third trigger event.

On the basis of any alternative technical solution in the embodiment of the present disclosure, alternatively, the third trigger event includes the video attribute information about the second video data satisfying a preset change condition.

The video data processing apparatus according to an embodiment of the present disclosure may execute the video data processing method according to any embodiment of the present disclosure, and has corresponding functional modules and advantageous effects for executing the video data processing method.

It should be noted that the various units and modules included in the above-mentioned apparatus are merely divided according to functional logic, but are not limited to the above-mentioned division, as long as corresponding functions can be realized; in addition, the specific names of the functional units are merely for convenience of mutual distinction and are not intended to limit the scope of the embodiment of the present disclosure.

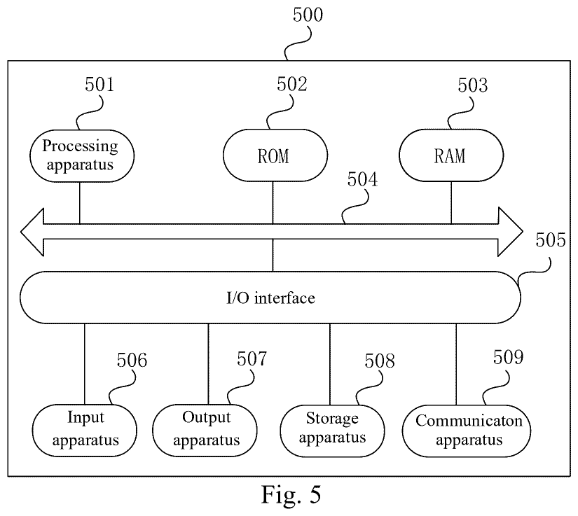

Reference is now made to FIG. 5, FIG. 5 illustrates a schematic structural diagram showing an electronic device (e.g., terminal device or server 500) suitable for implementing an embodiment of the present disclosure. The terminal devices in the embodiments of the present disclosure may include, but are not limited to, mobile terminals such as mobile phones, notebook computers, digital broadcast receivers, personal digital assistants (PDA), tablet computers (PAD), portable multimedia players (PMP), in-vehicle terminals (e.g., in-vehicle navigation terminals, etc.), and fixed terminals such as digital TVs, desktop computers, etc. The electronic device shown in FIG. 5 is only one example and should not impose any limitation on the functionality and scope of use of the embodiment of the present disclosures.

As shown in FIG. 5, the electronic device 500 may include a processing apparatus (e.g., central processor, graphics processor, etc.) 501 that may perform various suitable actions and processes according to a program stored in a read-only memory (ROM) 502 or a program loaded from the storage 508 into a random-access memory (RAM) 503. In the RAM 503, various programs and data required for the operation of the electronic device 500 are also stored. The processing apparatus 501, the ROM 502 and the RAM 503 are connected to each other via a bus 504. An input/output (I/O) interface 505 is also coupled to the bus 504.

In general, the following apparatuses may be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (LCD), a loudspeaker, a vibrator, etc.; a storage 508 including, for example, a magnetic tape, a hard disk, etc.; and a communication apparatus 509. The communication apparatus 509 may allow the electronic device 500 to be in wireless or wired communication with other devices to exchange data. While FIG. 5 illustrates an electronic device 500 having various apparatuses, it is to be understood that not all illustrated apparatuses are required to be implemented or provided. More or fewer apparatuses may alternatively be implemented or provided.

Specifically, the processes described above referring to the flowcharts may be implemented as a computer software program according to an embodiment of the present disclosure. For example, an embodiment of the present disclosure includes a computer program product including a computer program embodied on a non-transitory computer-readable medium, the computer program including program code for performing the methods illustrated in the flowcharts. In such an embodiment, the computer program may be downloaded and installed from the network via the communication apparatus 509, or from the storage 508, or from the ROM 502. The computer program, when executed by the processing apparatus 501, performs the functions defined above in the method of embodiments of the present disclosure.

The names of messages or information exchanged between multiple apparatuses in the embodiments of the present disclosure are for illustrative purposes only and are not intended to limit the scope of these messages or information.

The electronic device provided by the embodiments of the present disclosure shares the same inventive concept with the video data processing method provided in the aforementioned embodiments. Technical details not exhaustively described in the embodiments of the present disclosure may refer to the aforementioned embodiments, and the present embodiment achieves the same beneficial effects as the aforementioned embodiments.

The embodiments of the present disclosure provide a computer storage medium having stored thereon a computer program which, when executed by a processor, implements the video data processing method provided by the aforementioned embodiments.

It should be noted that the computer-readable medium described above in the present disclosure may be a computer-readable signal medium or a computer-readable storage medium, or any combination of the aforementioned two. The computer-readable storage medium may be, but is not limited to, an electrical, magnetic, optical, electromagnetic, infrared, or semiconductor system, apparatus or device, or any combination of the foregoing. More specific examples of computer-readable storage media may include, but are not limited to: an electrical connection having one or more wires, a portable computer diskette, a hard disk, a random-access memory (RAM), a read-only memory (ROM), an erasable programmable read-only memory (EPROM or flash memory), an optical fiber, a portable compact disk read-only memory (CD-ROM), an optical storage, a magnetic storage, or any suitable combination thereof. In this disclosure, a computer-readable storage medium may be any tangible medium that can contain or store a program for use by or in connection with an instruction execution system, apparatus, or device. In addition, in this disclosure, the computer-readable signal medium may include a data signal embodied in baseband or propagated as part of a carrier wave carrying computer-readable program code. Such propagated data signals may take many forms, including but not limited to electromagnetic signals, optical signals, or any suitable combination of the preceding. The computer-readable signal medium may also be any computer-readable medium other than a computer-readable storage medium that can send, propagate, or transport the program for use by or in connection with the instruction execution system, apparatus, or device. The program code embodied on a computer-readable medium may be transmitted over any suitable medium including, but not limited to, wire, fiber optic cable, radio frequency (RF), and the like, or any suitable combination of the preceding.

According to one or more examples of the present disclosure, a video data processing method is provided, which includes:
in response to a video generation request, obtaining first text prompt information corresponding to the video generation request; and inputting the first text prompt information into a first video generation model to obtain first video data corresponding to the video generation request, where the first video generation model is obtained by training a diffusion model via second video data; the second video data is generated by a second video generation model; and model parameters of the second video generation model are associated with model parameters of the diffusion model during model training.

According to one or more embodiments of the present disclosure, the method further includes, alternatively, a model structure of the second video generation model is the same as a model structure of the diffusion model; and during training of the diffusion model, in response to a first trigger event, the model parameters of the second video generation model are updated to the model parameters of the diffusion model.

According to one or more embodiments of the present disclosure, the method further includes: alternatively, the first trigger event includes at least one selected from a group consisting of the model parameters of the diffusion model being updated, a preset first update time condition being satisfied, and a number of updates of the diffusion model reaching a first number threshold.

According to one or more embodiments of the present disclosure, the method further includes: alternatively, during training, the model parameters of the first video generation model are adjusted according to a video generation loss; the video generation loss is determined according to a third video generation model; model parameters of the third video generation model are associated with the model parameters of the diffusion model during the model training.

According to one or more embodiments of the present disclosure, the method further includes:
alternatively, a model structure of the third video generation model is the same as a model structure of the diffusion model; during the training of the diffusion model, in response to a second trigger event, the model parameters of the third video generation model are updated to the model parameters of the diffusion model; an update frequency of the model parameters of the third video generation model is lower than an update frequency of the model parameters of the diffusion model.

According to one or more embodiments of the present disclosure, the method further includes: alternatively, the second trigger event includes at least one selected from a group consisting of meeting a preset second update time condition and a number of updates of the model parameters of the diffusion model reaching a second number threshold.

According to one or more embodiments of the present disclosure, the method further includes: alternatively, the first video generation model is trained by: obtaining second text prompt information and first noise information, inputting the second text prompt information and the first noise information into the second video generation model, and obtaining a plurality of second video data corresponding to the second text prompt information; determining video attribute information about a plurality of second video data, and determining third video data and fourth video data in the plurality of second video data according to the video attribute information about the second video data, where the video attribute information is used for representing difference information about the second video data on interaction effect data; and obtaining second noise information, adding the second noise information to the third video data to obtain fifth video data, adding the second noise information to the fourth video data to obtain sixth video data, and training a pre-established diffusion model via the fifth video data and the sixth video data to obtain the first video generation model.

According to one or more embodiments of the present disclosure, the method further includes: alternatively, the determining video attribute information about a plurality of second video data includes: inputting the plurality of second video data into a video detection model respectively to obtain video attribute information about each of the second video data, where the video detection model is obtained by training a machine learning model based on the seventh video data and a video attribute tag corresponding to the seventh video data.

According to one or more embodiments of the present disclosure, the method further includes: alternatively, the training a pre-established diffusion model via the fifth video data and the sixth video data to obtain the first video generation model, includes: inputting the second text prompt information, the fifth video data and the sixth video data into a pre-established diffusion model, and respectively obtaining third noise information corresponding to the fifth video data and fourth noise information corresponding to the sixth video data; and inputting the second text prompt information, the fifth video data and the sixth video data into the third video generation model, and respectively obtaining fifth noise information corresponding to the fifth video data and sixth noise information corresponding to the sixth video data; and determining a video generation loss according to the third noise information, the fourth noise information, the fifth noise information and the sixth noise information, adjusting the model parameters of the diffusion model according to the video generation loss, and determining the diffusion model, which is trained, as the first video generation model in response to a third trigger event.

According to one or more embodiments of the present disclosure, the method further includes: alternatively, the third trigger event includes the video attribute information about the second video data satisfying a preset change condition.

According to one or more embodiments of the present disclosure, a video data processing apparatus is provided, which includes:
a video generation request model configured for, in response to a video generation request, obtaining first text prompt information corresponding to the video generation request; and a video data generation module configured for inputting the first text prompt information into a first video generation model to obtain first video data corresponding to the video generation request; where the first video generation model is obtained by training a diffusion model via second video data; the second video data is generated by a second video generation model; and model parameters of the second video generation model are associated with model parameters of the diffusion model during model training.

In some embodiments, clients, servers may communicate using any currently known or future developed network protocol, such as HyperText Transfer Protocol (HTTP), and may be interconnected with any form or medium of digital data communication (e.g., a communication network). Examples of communication networks include local area networks (“LAN”), wide area networks (“WAN”), internetworks (e.g., the Internet), and peer-to-peer networks (e.g., the ad hoc peer-to-peer network), as well as any network currently known or developed in the future.

The computer-readable medium may be included in the electronic device; it may also be present separately and not fitted into the electronic device.

The above-mentioned computer-readable medium carries one or more programs, and when the above-mentioned one or more programs are executed by the electronic device, the electronic device is caused to: in response to a video generation request, obtain first text prompt information corresponding to the video generation request; and input the first text prompt information into a first video generation model to obtain first video data corresponding to the video generation request; where the first video generation model is obtained by training a diffusion model via second video data; the second video data is generated by a second video generation model; and model parameters of the second video generation model are associated with model parameters of the diffusion model during model training.

Computer program code for carrying out operations of the present disclosure may be written in one or more programming languages, including but is not limited to object-oriented programming languages, such as Java, smalltalk, C++, and conventional procedural programming languages, such as the “C” language or similar programming languages, or combinations thereof. The program code may execute entirely on the user's computer, partly on the user's computer, as a stand-alone software package, partly on the user's computer, partly on a remote computer, or entirely on the remote computer or server. In the case of a remote computer, the remote computer may be connected to the user computer through any kind of network, including a local area network (LAN) or a wide area network (WAN), or may be connected to an external computer (e.g., through the Internet using an Internet service provider).

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted which, in some alternative implementations, the functions noted in the blocks may occur in a different order than that noted in the drawings. For example, two consecutive blocks may in fact be executed substantially in parallel, and they may sometimes be executed in the reverse order, depending on the functionality involved. Each block of the block diagrams and/or flowchart illustrations, and combinations of blocks in the block diagrams and/or flowchart illustrations, can be implemented by special purpose hardware-based systems which carry out the specified functions or acts, or combinations of special purpose hardware and computer instructions.

The elements described in connection with the embodiments disclosed herein may be implemented in software or hardware. The name of a unit does not constitute a limitation on the unit itself in some cases, for example, a video generation request module may also be described as “a module configured to acquire first text prompt information corresponding to the video generation request”.

The functions described herein above may be performed, at least in part, by one or more hardware logic components. For example, without limitation, exemplary types of hardware logic components that may be used include: Field Programmable Gate Arrays (FPGA), Specific Integrated Circuits (ASIC), Specific Standard Products (ASSP), System on a Chip (SOC), Complex Programmable Logic Devices (CPLD), etc.

According to the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination as above. More specific examples of a machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage, a magnetic storage, or any suitable combination thereof.

The foregoing description is only illustrative of the preferred embodiments of the present disclosure and of the principles of the technology employed. It will be appreciated by a person skilled in the art that the scope of disclosure covered by the present disclosure is not limited to any particular combination of the features set forth above, but is intended to cover any combination of the features set forth above or their equivalents without departing from the spirit of the present disclosure. For example, the above-mentioned features and the technical features disclosed in the present disclosure (but not limited to) having similar functions are replaced with each other to form a technical solution.

Further, while operations are depicted in a particular order, this should not be understood to require that the operations be performed in the particular order shown or in a sequential order. Under certain circumstances, multitasking and parallel processing may be advantageous. As such, specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment can also be implemented in a plurality of embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A video data processing method, comprising:
in response to a video generation request, obtaining first text prompt information corresponding to the video generation request; and
inputting the first text prompt information into a first video generation model to obtain first video data corresponding to the video generation request,
wherein the first video generation model is obtained by training a diffusion model via second video data; the second video data is generated by a second video generation model; and model parameters of the second video generation model are associated with model parameters of the diffusion model during model training.

2. The video data processing method according to claim 1, wherein a model structure of the second video generation model is the same as a model structure of the diffusion model; and during training of the diffusion model, in response to a first trigger event, the model parameters of the second video generation model are updated to the model parameters of the diffusion model.

3. The video data processing method according to claim 2, wherein the first trigger event comprises at least one selected from a group consisting of the model parameters of the diffusion model being updated, a preset first update time condition being satisfied, and a number of updates of the diffusion model reaching a first number threshold.

4. The video data processing method according to claim 1, wherein during training, the model parameters of the first video generation model are adjusted according to a video generation loss; the video generation loss is determined according to a third video generation model; model parameters of the third video generation model are associated with the model parameters of the diffusion model during the model training.

5. The video data processing method according to claim 4, wherein a model structure of the third video generation model is the same as a model structure of the diffusion model; during the training of the diffusion model, in response to a second trigger event, the model parameters of the third video generation model are updated to the model parameters of the diffusion model; an update frequency of the model parameters of the third video generation model is lower than an update frequency of the model parameters of the diffusion model.

6. The video data processing method according to claim 5, wherein the second trigger event comprises at least one selected from a group consisting of meeting a preset second update time condition and a number of updates of the model parameters of the diffusion model reaching a second number threshold.

7. The video data processing method according to claim 1, wherein the first video generation model is trained by:
obtaining second text prompt information and first noise information, inputting the second text prompt information and the first noise information into the second video generation model, and obtaining a plurality of second video data corresponding to the second text prompt information; determining video attribute information about a plurality of second video data, and determining third video data and fourth video data in the plurality of second video data according to the video attribute information about the second video data, wherein the video attribute information is used for representing difference information about the second video data on interaction effect data; and
obtaining second noise information, adding the second noise information to the third video data to obtain fifth video data, adding the second noise information to the fourth video data to obtain sixth video data, and training a pre-established diffusion model via the fifth video data and the sixth video data to obtain the first video generation model.

8. The video data processing method according to claim 7, wherein the determining video attribute information about a plurality of second video data, comprises:
inputting the plurality of second video data into a video detection model respectively to obtain video attribute information about each of the second video data, wherein the video detection model is obtained by training a machine learning model based on the seventh video data and a video attribute tag corresponding to the seventh video data.

9. The video data processing method according to claim 7, wherein the training a pre-established diffusion model via the fifth video data and the sixth video data to obtain the first video generation model, comprises:
inputting the second text prompt information, the fifth video data and the sixth video data into a pre-established diffusion model, and respectively obtaining third noise information corresponding to the fifth video data and fourth noise information corresponding to the sixth video data; and
inputting the second text prompt information, the fifth video data and the sixth video data into the third video generation model, and respectively obtaining fifth noise information corresponding to the fifth video data and sixth noise information corresponding to the sixth video data; and
determining a video generation loss according to the third noise information, the fourth noise information, the fifth noise information and the sixth noise information, adjusting the model parameters of the diffusion model according to the video generation loss, and determining the diffusion model, which is trained, as the first video generation model in response to a third trigger event.

10. The video data processing method according to claim 9, wherein the third trigger event comprises the video attribute information about the second video data satisfying a preset change condition.

11. An electronic device, comprising:
one or more processors; and
a storage for storing one or more programs,
wherein when the one or more programs are executed by the one or more processors, the one or more processors are caused to implement a video data processing method, and
wherein the video data processing method comprises:
in response to a video generation request, obtaining first text prompt information corresponding to the video generation request; and
inputting the first text prompt information into a first video generation model to obtain first video data corresponding to the video generation request,
wherein the first video generation model is obtained by training a diffusion model via second video data; the second video data is generated by a second video generation model; and model parameters of the second video generation model are associated with model parameters of the diffusion model during model training.

12. The electronic device according to claim 11, wherein a model structure of the second video generation model is the same as a model structure of the diffusion model; and during training of the diffusion model, in response to a first trigger event, the model parameters of the second video generation model are updated to the model parameters of the diffusion model.

13. The electronic device according to claim 12, wherein the first trigger event comprises at least one selected from a group consisting of the model parameters of the diffusion model being updated, a preset first update time condition being satisfied, and a number of updates of the diffusion model reaching a first number threshold.

14. The electronic device according to claim 11, wherein during training, the model parameters of the first video generation model are adjusted according to a video generation loss; the video generation loss is determined according to a third video generation model; model parameters of the third video generation model are associated with the model parameters of the diffusion model during the model training.

15. The electronic device according to claim 14, wherein a model structure of the third video generation model is the same as a model structure of the diffusion model; during the training of the diffusion model, in response to a second trigger event, the model parameters of the third video generation model are updated to the model parameters of the diffusion model; an update frequency of the model parameters of the third video generation model is lower than an update frequency of the model parameters of the diffusion model.

16. The electronic device according to claim 15, wherein the second trigger event comprises at least one selected from a group consisting of meeting a preset second update time condition and a number of updates of the model parameters of the diffusion model reaching a second number threshold.

17. The electronic device according to claim 11, wherein the first video generation model is trained by:
obtaining second text prompt information and first noise information, inputting the second text prompt information and the first noise information into the second video generation model, and obtaining a plurality of second video data corresponding to the second text prompt information; determining video attribute information about a plurality of second video data, and determining third video data and fourth video data in the plurality of second video data according to the video attribute information about the second video data, wherein the video attribute information is used for representing difference information about the second video data on interaction effect data; and
obtaining second noise information, adding the second noise information to the third video data to obtain fifth video data, adding the second noise information to the fourth video data to obtain sixth video data, and training a pre-established diffusion model via the fifth video data and the sixth video data to obtain the first video generation model.

18. The electronic device according to claim 17, wherein the determining video attribute information about a plurality of second video data, comprises:
inputting the plurality of second video data into a video detection model respectively to obtain video attribute information about each of the second video data, wherein the video detection model is obtained by training a machine learning model based on the seventh video data and a video attribute tag corresponding to the seventh video data.

19. The electronic device according to claim 17, wherein the training a pre-established diffusion model via the fifth video data and the sixth video data to obtain the first video generation model, comprises:
inputting the second text prompt information, the fifth video data and the sixth video data into a pre-established diffusion model, and respectively obtaining third noise information corresponding to the fifth video data and fourth noise information corresponding to the sixth video data; and
inputting the second text prompt information, the fifth video data and the sixth video data into the third video generation model, and respectively obtaining fifth noise information corresponding to the fifth video data and sixth noise information corresponding to the sixth video data; and
determining a video generation loss according to the third noise information, the fourth noise information, the fifth noise information and the sixth noise information, adjusting the model parameters of the diffusion model according to the video generation loss, and determining the diffusion model, which is trained, as the first video generation model in response to a third trigger event.

20. A non-transitory storage medium comprising computer-executable instructions, wherein when executed by a computer processor, the computer-executable instructions are used for executing a video data processing method,
wherein the video data processing method comprises:
in response to a video generation request, obtaining first text prompt information corresponding to the video generation request; and
inputting the first text prompt information into a first video generation model to obtain first video data corresponding to the video generation request,
wherein the first video generation model is obtained by training a diffusion model via second video data; the second video data is generated by a second video generation model; and model parameters of the second video generation model are associated with model parameters of the diffusion model during model training.
